(19) United States
(12) Patent Application Publication
(10) Pub. No.: US 2024/0081199 A1
(43) Pub. Date: Mar. 14, 2024

(54) SCREEN FOR GREENHOUSE

(71) Applicant: INFRASCREEN SA, Neuchâtel (CH)

(72) Inventor: Benoît De Combaud, Buchillon (CH)

(21) Appl. No.: 18/263,869

(22) PCT Filed: Feb. 2, 2022
(86) PCT No.: PCT/EP2022/052429

§ 371 Date: Aug. 1, 2023

(30) Foreign Application Priority Data
Feb. 2, 2021 (CH) 00096/21

(51) Int. Cl. A01G 9/14

(52) U.S. Cl. CPC A01G 9/1438; A01G 2009/1453

(57) ABSTRACT

The invention concerns a foldable greenhouse screen (2) comprising strips (11) of film material that are interconnected by a yarn system of threads (12) by means of knitting, warp-knitting or weaving process to form a continuous product, at least some of said strips (11) comprising a substrate (061) covered with a stack of thin films (063) on a first side of the substrate, so that said greenhouse screen has: a transparency coefficient of at least 40% but no more than 80% in the range of solar radiations, and a reflection coefficient higher than 70% in the middle infrared.

### CROSS-REFERENCE

The present Application for Patent claims priority to European Patent Application No. PCT/EP2022/052429 by De Combaud, entitled “SCREEN FOR GREENHOUSE”, filed Feb. 2, 2022, which claims priority to Swiss Patent Application No. 00096/21 by De Combaud, entitled “A SCREEN FOR GREENHOUSE OR FOR OUTDOOR CULTIVATIONS”, filed Feb. 2, 2021, each of which is assigned to the assignee hereof, and each of which is expressly incorporated by reference in its entirety herein.

### FIELD OF THE INVENTION

The present invention concerns a screen for greenhouse adapted to reduce heat stress from the sun by providing shading to the crop (i.e., reflecting and absorbing sun radiations away from the crop with some degree of selectivity) and reduce both convective and radiative heat losses from the greenhouse.

The present invention further concerns a method of fabricating such a foldable screen.

### DESCRIPTION OF RELATED ART

DE 103 18 877 A1 discloses a translucent covering material consisting of at least one textile grid structure onto which a polymer film is laminated. In front of the side of the film facing away from the textile grid, there is a system of PVD layers consisting of at least three individual layers, including at least one metal layer embedded between two dielectric layers.

WO 2013/041524 A1 shows a greenhouse screen comprising strips of film material and WO 2011/109306 A2 discloses an EMI shielding transparent film for use in association with office window glazing.

Solar radiations are in the range from 300 nm to 2′500 nm of the light spectrum. Solar radiations can be divided into ultraviolets from 300 to 400 nm, photosynthetic active radiations in the spectral range from 400 nm to 700 nm (the so-called PAR range), and non-photosynthetic radiation in the spectral range from 700 nm to 2′500 nm. Radiations up to 750 nm may also impact photosynthesis and plant morphogenesis. For instance, it has been demonstrated that the ratio between red (660 nm) and far-red (730 nm) has a significant impact on morphogenesis. We will therefore refer to extended photosynthesis radiation (ePAR) for radiations in the spectral range from 400 nm to 750 nm.

Sun transfers energy to greenhouses through radiations: electromagnetic wave with wavelength in the range of 400-2′500 nm flow from the sun to the greenhouse. The greenhouse loses energy through conduction, convective air flow, and radiations in the middle infrared with wavelength range.

Curtains have been used in greenhouses to control the ins and outs of energy energies from the inside and from the outside of the greenhouse.

Deployable screens have been developed to manage radiation and convection transfers.

So called “blackout screens” are designed to block all sun radiations as well as, in most designs, radiations in the middle infrared spectrum. When deployed, sun radiations are prevented to reach the crop. Such screens have by design a closed structure, thus preventing air transfer and heat loss by convection. These screens are normally used during the night to prevent light pollution or during the day to control photoperiod of sensitive crops, such as flowers.

In addition, so called “mixed screens” partially suppress transfer of sun radiations as well as, with a reflective material made of aluminium, reduce heat loss by radiations. As “blackout screens”, those screens have a closed structure preventing air transfer hence heat loss by convection. These screens are normally used in winter during the night to reduce heat loss and in summer, during the day, to offer limited shading.

So called “shading screens” partially suppress transfers of sun radiations and, with a reflective material made of aluminum, reduce partially heat losses by radiations. Contrary to “blackout screens” and “mixed screens”, those screens have an open structure allowing air transfers. They are normally used during the day in summer to offer limited shading and during winter night in combination with a “thermal screen” to partially reduce heat losses by radiations.

So called “thermal screens”, as disclosed for example in WO2013/041524, are designed to maximize the transfer of sun radiations while suppressing convective heat losses due to air transfers. Those screens have a closed structure and are normally used in winter, during the night and sometimes, depending on the tradeoff of possible energy saving and reduction of sunlight reduction, during part of the day.

“Blackout screens”, “mixed screens”, “shading screens” and “thermal screens” can be used solely or in combination. In one recent development, the combination of a “blackout screen” with a very diffusive “thermal screen” is used to reduce heat loss by radiations and convection during the night in winter and to offer shading during summer.

Only a limited part of the sun radiations, in the 400-750 nm range, is used for photosynthesis and photomorphogenesis. Depending on growth stage of the crop, optimization of growth can be done by allowing different levels of radiations depending on the wavelength. However, prior art screens do not differentiate transfer and reflection of radiations according to wavelength.

Window films are designed to filter sun radiations as well as middle infrared radiations through windows; they are used to retrofit windows in houses or cars. These films are described in different patents such as U.S. Pat. No. 5,589,280 by Southwall Technologies Inc., or in U.S. Pat. No. 5,563,734 by the BOC Group Inc. Different designs are possible. For instance, many window films are based on a short wave pass flexible filter based on the deposition of a Dielectric/Metal/Dielectric structure or a repetition of such a structure on a flexible transparent polymer.

Single layer metallic thin films like Ag and Au are typically semitransparent with significant reflectance. However, if an antireflective, high index transparent layer is placed on either side of the metallic thin film, the three-layer stack produces an optically enhanced metallic thin film which is highly transparent. This three-layer construction is called an induced transmission filter.

Using so called “window films” in the design of greenhouse screen is a promising solution for reducing heat losses in winter and heat stress in summer. However, using window films in the manufacturing of greenhouse screens is technically difficult and commercially not viable.

We define shading percentage (or shading coefficient) as the percentage of light arriving at normal incidence on the screen and that is either absorbed or reflected. To shade the crop, a screen placed over the crop can either prevent sunlight to reach the crop by absorption (the light is absorbed and converted in heat by the screen) or by reflection (the light is reflected by the screen outside the greenhouse). Reflection will be favoured but in practice there is always a mix of absorption and reflection.

When shading, it is possible to absorb/reflect the full spectrum of incoming sunlight or only part of it. There are spectral ranges in the incoming sunlight that are less important than other for the photosynthesis of the crop; hence, it would be beneficial to shade these spectral ranges over other more photosynthetic spectral ranges. In particular, it would be beneficial to shade the near infrared radiations in the 750-2′500 nm range rather than the high photosynthetic radiations with wavelengths in the 400-750 nm range. It would also be preferred to shade the green spectrum range (490-620 nm) and to some extent the blue spectrum range (410-490 nm) rather than the red spectrum range (620-700 nm) which is often the most important for photosynthesis.

### Aim of the Invention

The purpose of the present invention is hence to provide an improved screen for greenhouses.

In particular, the greenhouse screen should be better adapted to summertime radiation conditions but can also be used to reduce heat loss during wintertime.

In addition, the screen improves growth of cultures growing inside the greenhouse and reduces losses due to excessive solar radiation.

Additionally, the screen allows for a reduction in heat losses, in particular during winter conditions.

Furthermore, the greenhouse screen can be fabricated easily at low cost.

### BRIEF SUMMARY OF THE INVENTION

According to one aspect, those aims are achieved with a foldable greenhouse screen comprising strips of film material that are interconnected by a yarn system of threads by means of knitting, warp-knitting or weaving process to form a continuous product, at least some of said strips being filtering strips and comprising a transparent substrate in the form of a single or multilayer polymeric film covered on a first side with a stack of thin films, said stack comprising at least one dielectric layer, a metal layer or another IR reflecting layer and a second dielectric layer, selected so that said greenhouse screen has either:
a transparency coefficient (according to NEN 2675+C1:2018 5.3) of at least 40% but no more than 80% in the range of solar radiations, and a reflection coefficient higher than 80% in the middle infrared range (3′000 nm to 40′000 nm); or
a transparency coefficient of at least 60% but no more than 80% in the range of solar radiations, and a reflection coefficient higher than 70% in the middle infrared range.

The transparency and reflection properties of this screen allows for shading in summer and reduces convection and radiation losses in winter.

The screen reflects thermal radiation in the middle infrared range lossed by the plants, preventing them from leaving the greenhouse.

Thanks to the structure with strips, the screen allows water vapour to be transmitted while blocking air exchange.

In an embodiment, the greenhouse screen has a transparency coefficient of at least 40% and a reflection coefficient of at least 80% in the middle infrared range.

The transparency coefficient and the reflection coefficient correspond to average values over the whole spectral range considered here.

The reflection and transparency coefficients (according to NEN 2675+C1:2018 5.3) are determined at normal incidence.

Crop, soil and the greenhouse structure radiate energy in the form of electromagnetic radiations. Near 300K, such radiations have a wavelength in the middle infrared spectrum. By preventing middle infrared spectrum to leave the greenhouse, radiative heat losses can be reduced/suppressed. A first solution would be to offer a horizontal middle infrared reflecting surface placed over the crop, soil, or greenhouse structure. However, this would result in a middle infrared reflecting surface cooler than air temperature, which might promote condensation. Water droplets might fall over the crop which is not wanted as it risks promoting fungus development.

A favored solution is to have an horizontal surface with a lower face which faces the crop which absorbs a significant amount, such as more than 40%, of the middle infrared radiations, while the upper face which faces the sky reflects the middle infrared radiations. This way, the risk of condensation on the horizontal surface which faces the crop will be reduced since the surface is warmer, while the reflecting surface reflects the portion of the middle infrared which passes the film and prevents the emission of heat radiation toward the sky.

The greenhouse screen can have a transparency of more than 80% in the ePAR range.

The greenhouse screen can have a transparency higher than 20% in the near infrared range (NIR), to reduce the manufacturing costs. The greenhouse screen preferably shades more than 40% of sun radiations while reducing thermal radiative heat losses by more than 70%.

The greenhouse screen preferably shades more than 40% of sun radiations while reducing thermal radiative heat losses by more than 80%.

Preferably, the greenhouse screen can have a haze of less than 18%, such as less than 8%, such as less than 3%. This haze can be achieved with an appropriate selection of the substrate, and/or with additional, non-filtering strips.

The edges of the metal layer are preferably protected against corrosion.

The whole screen is preferably compliant with norm DIN4102 for low flammability.

The water vapor transmission of the screen permits a control of the humidity level in the greenhouse. The water vapor transmission is mainly controlled by the width of the strips and the type of yarn used.

In order to facilitate water/vapor transfer through the screen, water transfer between the underside and the upper side can take place in a capillary manner along the yarn. This arrangement also prevents holes in the fabric from being blocked by water drops which would reduce the moisture transfer. A more or less branching thread network will influence the capillary transfer or the binding of water.

By arranging the threads closely on the underside, this side has a textile appearance and properties, and can absorb large amounts of water, hence avoiding condensing drops and a wet upperside.

The strips are preferably adjacent to avoid convective heat loss between the strips. The strips can be located side by side closely to each other with only mesh staples between them, forming an essentially unbroken connected surface.

The screen can comprise exclusively filtering strips of the above-mentioned type.

Alternatively, the screen can comprise strips of the above-mentioned type and other strips of a different type. For example, the screen can comprise different variation of strips of the above-mentioned type and other strips of a different type.

The combination of strips of at least two different types results in a screen with the above-mentioned transparency and reflectivity, and with the desired properties.

At least some of the filtering strips can have a layered structure comprising consecutively: a transparent substrate layer, an optional underlayer, an infrared reflecting layered structure, an optional protective overcoat and a transparent protective layer (top-coat).

The thickness of the transparent substrate is a trade-off between reducing the risk of film damages and the risk of excessive shading by the screen when folded.

In one embodiment, the substrate includes UV blockers.

To avoid condensing drops, the underside which faces the crop must be kept warm. This is possible by making the upper side which faces the sky reflecting thermal radiations and the underside which faces the crop absorbing thermal radiations. In a particularly preferred embodiment according to the invention, the underside of the substrate is hydrophilic with a water contact angle <90°, preferentially <60°.

For the filtering strips, a privileged solution is to choose a substrate which absorbs at least 30%, preferably at least 50%, of the radiations in the middle infrared range.

In that case, the portion of the radiations that are absorbed by the lower side of the screen, including the substrate, will cause an increase in the temperature of the lower surface of the screen. Like all hot bodies, this surface will re-emit energy in the form of radiations in the middle infrared range. Half of these radiations will be re-emitted towards the ground and half towards the upper side of the screen. This portion of the radiation directed towards the upper side of the screen will be reflected, at least in part, by the stack of thin films on this upper side of the screen, so that it will not leave the greenhouse but will return towards the ground. In this way, a high reflection rate can be guaranteed to avoid heat losses by radiation in the MIR range during the winter.

Obviously, those radiations will not leave the greenhouse in summer either. However, the increase in temperature caused by the capture of the radiations in the MIR range in summer is negligible compared to the drop in temperature obtained through shading across the entire range of solar radiation, particularly in the ranges of wavelengths which are less useful for the photosynthesis.

The face of the transparent substrate layer of the filtering strips on which the stack of thin film will be deposited should have a high adhesion with dielectric material and a very smooth surface in order to reduce the risk of pinholes formations that will reduce the life expectancy of the screen. In the context of the present invention, a surface is considered to be very smooth if the root mean squared roughness (RMS) is below 1 nm, preferably below 0.5 nm and most preferred below 0.4 nm.

In one embodiment of the invention, the metal layer is a copper or copper alloy containing layer. Such a layer can be produced at relatively low cost, is relatively easy to protect against corrosion, has good adhesion with most high refractive transparent dielectric materials and interesting absorption in the blue/green versus red part of the sunlight spectrum.

In another embodiment of the invention, the metal layer is a silver or non-tarnishing silver alloy containing layer. Such a layer offers lower absorption and higher reflexion as well as better transmission in the photosynthetic part of the solar spectrum. To improve corrosion resistance, a layer based on a silver alloy is preferably used. Silver alloys comprising gold and/or palladium could be considered. Less expensive alloys with corrosion resistance properties could also be considered, such as the alloy disclosed in EP3168325A1.

The thickness of the metal layer can be in a range from 5 to 50 nm. Preferably, the metal layer has a thickness of 6 nm to 40 nm, particularly preferred 7 nm to 30 nm.

In a particularly preferred embodiment according to the invention, a transparent conducting oxide (TCO) is used as an IR-reflecting layer in the infrared reflecting layered structure. The TCO is preferably based on a layer of Indium Tin Oxide (ITO) with a thickness of 100-200 nm, preferably 130-170 nm, or a layer of Fluoride Tin Oxide (FTO) with a thickness of 300-700 nm, preferably 450-550 nm. As for stacks comprising a metal layer, the TCO layer is placed between the first dielectric layer and the second dielectric layer. A stack based on a TCO layer may preferentially comprise further layers.

The thickness of the dielectric layers can be in a range from 10 to 100 nm. Preferably, the dielectric layers have a thickness of 10 nm to 80 nm.

The stack of thin films can comprise an organic top-coat layer on top of the stack of thin film. The top-coat layer can cover all the other layers as well as the edges of the strips.

The organic top layer is preferentially thin enough to marginally reduce MIR transmission reflected by the metal layer. The organic top coat layer is preferably water-repellant or hydrophobic with a water contact angle >90°, preferably >100°, most preferred >120°. The organic top coat preferably comprises a fluorocarbon or Silicone and is preferably deposited in a solvent free low temperature process such as PECVD or PVD.

The metal layer in the stack of thin film can be encapsulated between two high refractive index dielectric layers in a way that the metal layer edges are in direct contact with the dielectric layer and not with air. A metal layer having good adhesion with those dielectric layers will be favored as it would be difficult to add an adhesion layer over the edges of the metal layer before the dielectric layer.

Preferentially the stack of thin films can comprise three layers of metallic oxide or nitride with two high refractive index metal oxide such as TiOa and one low refractive index metal oxide or nitride such as SiOa acting both as a barrier layer and protecting the metal layer and allowing a better cut of near infrared.

The invention is also related to a method of manufacturing a filtering film for a greenhouse screen, comprising:
i) providing a transparent substrate film;
ii) depositing different layers over the transparent substrate film.

The invention is further related to a method of manufacturing a greenhouse screen comprising:
i) providing rolls of filtering films and of regular film;
ii) cutting the different films in strips;
iii) incorporating the different strips in a textile framework.

The invention is further related to a method of manufacturing a foldable screen, comprising:
providing a substrate;
depositing an infrared reflecting layered structure on said substrate, said infrared reflecting layered structure comprising at least one stack with one dielectric layer, one metal layer and a second dielectric layer, said infrared reflecting layered structure being selected so that greenhouse screen has either:
a transparency coefficient between 40 and 80% for solar radiations, and a reflection coefficient higher than 80% in the middle infrared, or:
a transparency coefficient between 40 and 60% for solar radiations, and a reflection coefficient higher than 70% in the middle infrared.

The following embodiments and aspects of the invention are not restricted to the values of the transparency coefficient or the values of the reflection coefficient or to the spectral ranges of the embodiments of the invention as described in the passages above. Therefore, the following aspects and embodiments of the invention apply to a wide range of filtering strips for all spectral ranges.

According to another aspect of the invention a filtering strip (20) of a foldable greenhouse screen (2) is provided, comprising a transparent substrate (061) in the form of a single or multilayer polymeric film covered on a first side with an infrared reflecting layered structure (063), said infrared reflecting layered structure (063) comprising at least one stack with a first dielectric layer (071)
a metal layer (072) or IR-reflecting layer (072) and
a second dielectric layer (073)
having corrosion protection means for protecting the metal layer (072) or IR-reflecting layer (072) against corrosion or oxidation.

According to another aspect of the invention, the corrosion protection means comprise encapsulating means for encapsulating the metal layer (072) or IR-reflecting layer (072) by avoiding a direct air/metal interface.

According to another aspect of the invention, the metal layer (072) or the IR-reflecting layer (072) is encapsulated by a first dielectric layer (071) and a second dielectric layer (073).
It is understood, that the invention includes an infrared reflecting layered structure comprising more than one stack with a first dielectric layer (071) a metal layer (072) or IR-reflecting layer (072) and
a second dielectric layer (073)
having corrosion protection means for protecting the metal layers (072) or IR-reflecting layers (072) against corrosion or oxidation.

According to another aspect of the invention, a foldable greenhouse screen (2) is provided, comprising strips (20) of film material that are interconnected by a yarn system of threads (23, 24) by means of knitting, warp-knitting or weaving process to form a continuous product,
at least some of said strips being filtering strips (20), comprising a transparent substrate (061) in the form of a single or multilayer polymeric film covered on a first side with an infrared reflecting layered structure (063), said infrared reflecting layered structure (063) comprising
at least one stack with
a first dielectric layer (071)
a metal layer (072) or IR-reflecting layer (72) and
a second dielectric layer (073)
having corrosion protection means for protecting the metal layer (072) or IR-reflecting layer (072) against corrosion or oxidation.

According to another aspect of the invention in the foldable greenhouse screen (2) the corrosion protection means include encapsulating means for encapsulating the metal layer (072) or IR-reflecting layer (072) with no direct air/metal interface.

In a particularly preferred embodiment according to the present invention, the infrared reflecting layered structure (063) is a low-e film with an emissivity of less than 0.35, preferably less than 0.25, more preferred less than 0.15.

In a further preferred embodiment according to the invention, the layer stack is of the form: first dielectric layer/ZnO/Ag-layer/Blocker layer/ZnO/second dielectric layer/Overcoat/top coat. The layer stack may comprise further layers such as an underlayer.

### BRIEF DESCRIPTION OF THE DRAWINGS

The invention will be better understood with the aid of the description of embodiments illustrated by the figures, in which:

FIG. 1 shows a greenhouse with one screen according to an embodiment of the invention.

FIG. 2 shows strips of a film interlaced with a yarn framework.

FIGS. 3 to 6 show various manners of interconnecting strips with a yarn framework.

FIG. 7 is a cross-sectional view of one embodiment of a filtering strips which includes a substrate, an underlayer, an infrared reflecting structure, an optional protective overcoat and a top coat.

FIG. 8-10 show different embodiments of infrared reflecting layered structures according to the present invention.

FIG. 11 shows a simulation of the transmission (T) and reflexion (R) coefficients in the 400-10′000 nm spectrum of two infrared reflecting layered structures where the dielectric D is a titanium oxide thin film and the metal M is either a copper or a silver thin film.

FIG. 12, 13, 14, 14′, 15, 16, 17 show different embodiments of stacks in which the edges of the metal layer are protected.

FIG. 18, 18′, 18″ schematically illustrates a process of manufacturing a plurality of strips from a roll of substrate material.

FIG. 19, 19′, 20, 21 schematically illustrates various methods of manufacturing a plurality of strips on the same filtering film.

FIG. 22, 23 show different embodiments of infrared reflecting layered structures according to the present invention.

FIG. 24 shows an embodiment of an IR-reflecting layered structure according to the present invention with protected edges.

### DETAILED DESCRIPTION OF POSSIBLE EMBODIMENTS OF THE INVENTION

### Screen

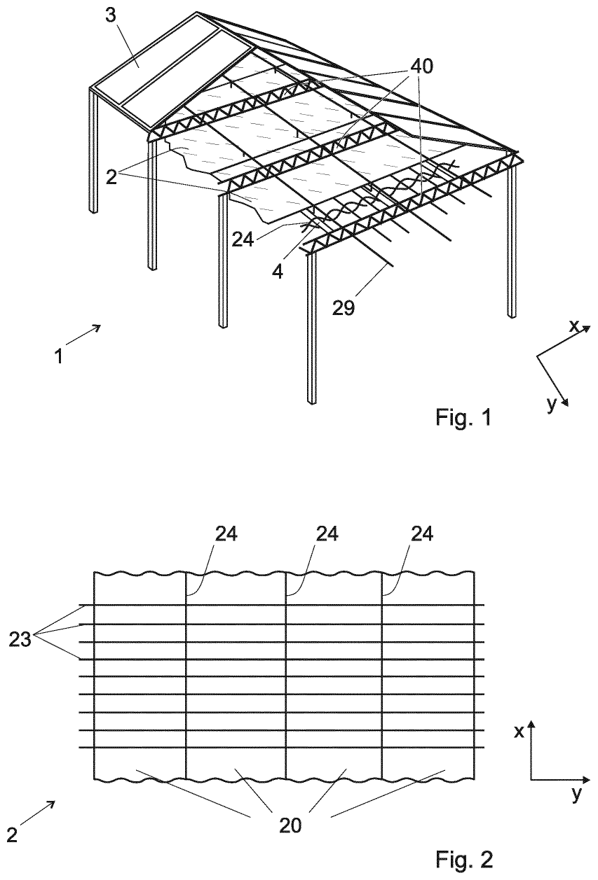

FIG. 1 shows a greenhouse 1 with a plurality of screens 2, as well as a cable mechanism 4 used to fold or unfold the screens by pulling them across or aside. Contrary to a cladding 3 which is fixed, such as a glass cladding, a screen 2 can be moved to cover or uncover the crop under production. The screens can glide between cables 29 under the screens to support them, and cables above the screens to prevent them from flying away.

As shown on FIG. 2, each screen 2 comprises a plurality of strips 20 held together by a yarn framework 23, 24. Each strip is flexible.

The strips 20 are preferably arranged closely edge to edge, so as to form a substantially continuous surface. In the figures, the distance between the strips 20 has been exaggerated to make the yarn framework visible.

The screen 2 has a longitudinal direction x and a transverse direction y. The strips 20 extend in the longitudinal direction. In another embodiment, some or all the strips may extend also in the transverse direction.

A typical width of the strips is between 2 mm and 10 mm but they can also be wider. In FIG. 2 the strips of film material 20 are interconnected with warp threads 24 primarily extending in the longitudinal direction x. The warp threads 24 are connected to one another by weft threads 23 extending transversally across the film strips. The term “transversally” in this respect is not restricted to a direction perpendicular to the longitudinal direction but means that the connecting weft threads 23 extends across the strips 20 as illustrated in the drawings.

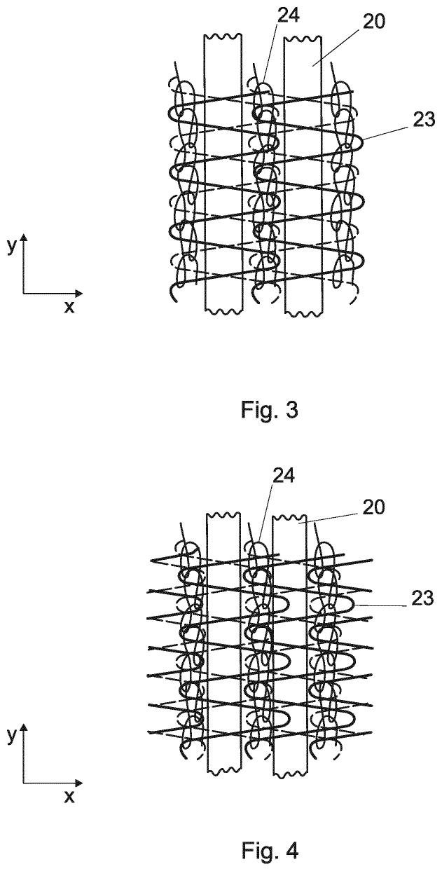

In FIG. 3, the strips of film material 20 are interconnected by warp knitting, for example as described in EP0109951. The yarn framework comprises warp threads 24 forming loops or stitches and primarily extending in the longitudinal direction x. The warp threads 24 are connected to one another by weft threads 23 extending transversally across the film strips.

FIG. 3 shows an example of a mesh pattern that could be used for the screen of the invention. The pattern is manufactured through a warp knitting process in which four guide bars are used, one for the strips of film material, two for the connecting weft threads 23 extending transversely to the film strips and one for the longitudinal warp threads 24.

The strips 20 are preferably located closely edge to edge. The longitudinal warp threads 24 are arranged on the underside of the screen, while the transverse connecting weft threads 23 are located on both sides strip, the upperside and the underside.

The arrangement of strips 20 and threads 23, 24 form a fabric.

The connection between the longitudinal warp threads 24 and the transverse weft threads 23 are preferably made on the underside of the strips. The strips of film material 20 can in this way be arranged closely edge to edge without being restricted by the longitudinal warp threads 24. The longitudinal warp threads may extend continuously in unbroken fashion along opposite edges of adjacent strips 20, in a series of knitted stitches, in a so-called open pillar stitch formation.

The transverse weft threads 23 pass above and below the strips 20 at the same location, i.e., opposed to each other, to fixedly trap the strips of film material. Each knitted stitch in the longitudinal warp threads 24 has two such transverse weft threads 23 engaging with it.

FIG. 4 shows another example of a mesh pattern for a fabric similar to the one shown in FIG. 3. The difference is that the transverse weft threads 23 pass over one and two strips of film material 20 in an alternating way.

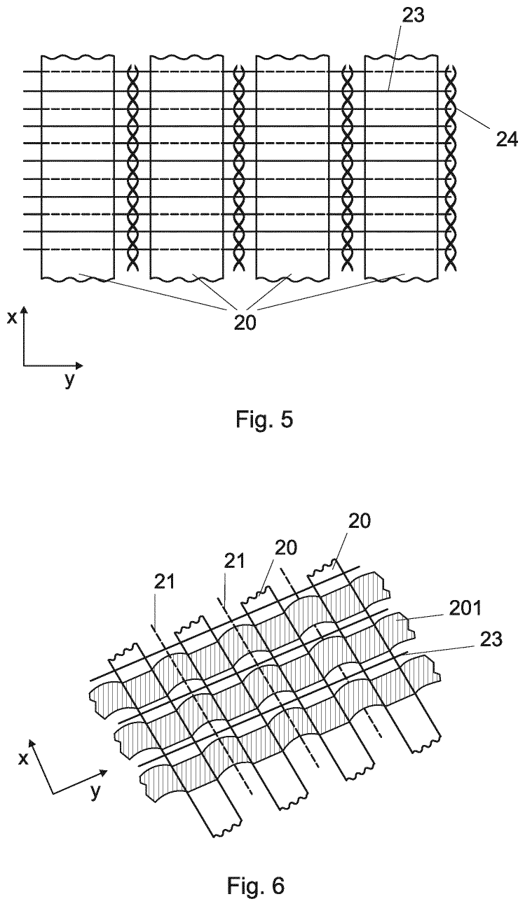

FIG. 5 shows a woven screen in which the strips 20 are interconnected by warp threads extending in longitudinal direction x, and interwoven with weft threads extending across the strips of film material primarily in the transverse direction y.

FIG. 6 shows another embodiment of a woven screen comprising strips of film material 20 (warp strips) extending in longitudinal direction x, and other strips of film material 201 (weft strips) extending in transverse direction y. The weft strips 201 in the transverse direction may as shown in FIG. 6 always be on the same side of the warp strips 20 in longitudinal direction or may alternate on the upper and underside of the warp longitudinal strips 20. The warp and weft strips 20, 201 are held together by a yarn framework comprising longitudinal and transverse threads 23, 21. The screen 2 may comprise open areas that are free from strips to reduce heat build-up under the screen.

The length of the strips in the direction x is at least equal to the width of one bay of the greenhouse. In most greenhouses, the width of the bays is a multiple of 3.20 meters such as 6.40 meters, 9.60 meters, 12.80 meters and occasionally 16.00 meters.

The width of the screen in the direction y is equal to the distance between two trusses 40 of the greenhouse. In most plastic covered greenhouses, this distance is 2.50 meters or 3.00 meters and, in most glass covered greenhouses this distance is 4.50 meters or 5.00 meters.

### Filtering Strips

A single greenhouse screen 2 can comprise different types of strips 20.

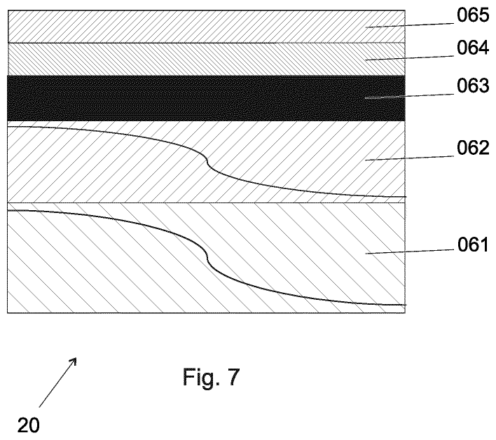

As shown in FIG. 7, at least some of the strips 20 of the greenhouse screen (“the filtering strips”) have a layered structure comprising consecutively: a transparent substrate layer 061, an optional underlayer 062, an infrared reflecting layered structure 063, an optional protective overcoat 064 and a transparent protective top-coat layer 065.

The structure and layers of the strips is arranged so that the greenhouse screen has a transparency coefficient of at least 40% but no more than 80% in the range of solar radiations. In a preferred embodiment, the screen shades more than 60% of sun radiations while reducing thermal radiative heat loss by more than 70%.

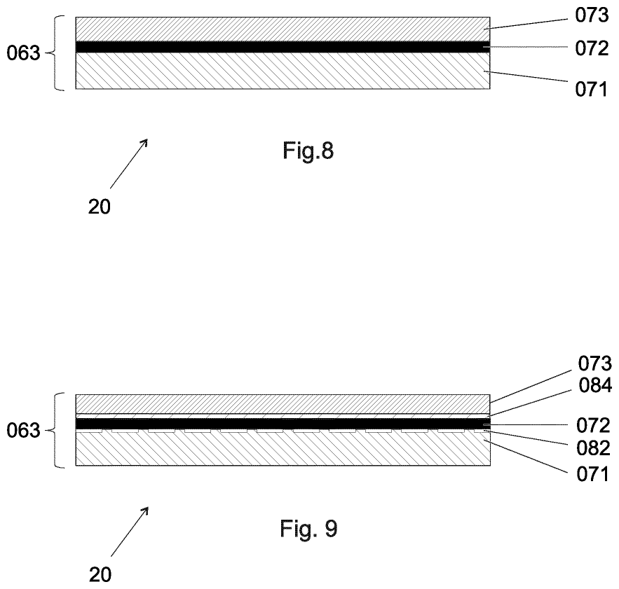

As shown on FIG. 8, the infrared reflecting layered structure 063 comprises a stack with at least one Insulator layer 071/one Metal layer 072 I one Insulator layer 073. The expression “metal layer” includes layers comprising exclusively or not exclusively metal. A “metal layer” may also be a transparent conducting oxide. A “metal layer” may be a complete discontinuous layer or a layer presenting openings, gaps or holes.

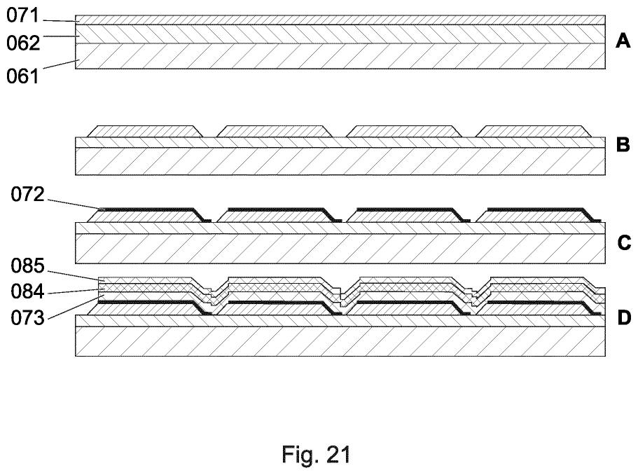

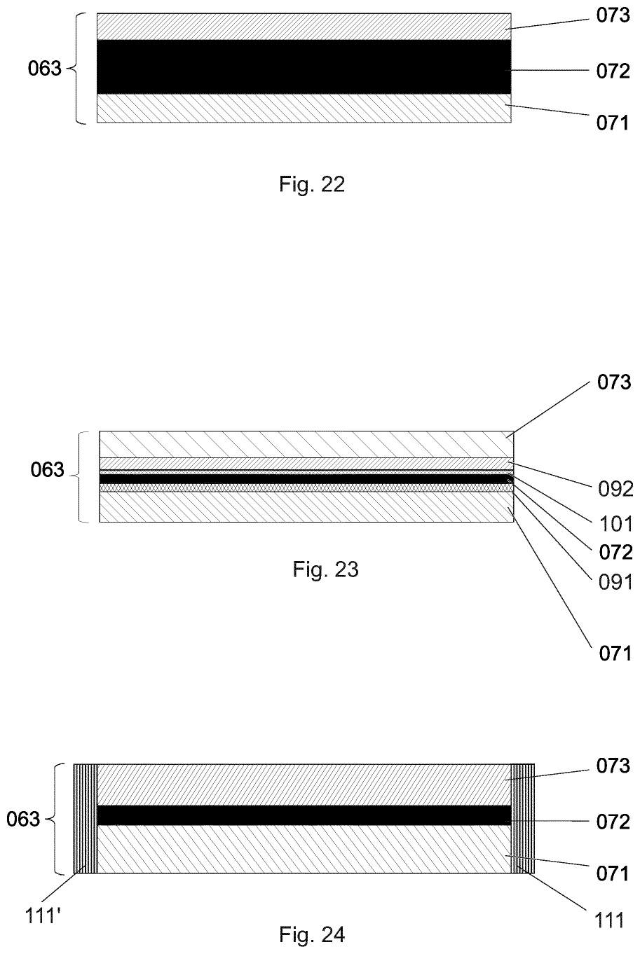

An illustrative example for a TCO-based IR-reflecting stack is shown in FIG. 22. The infrared reflecting layered structure 63 comprises a first dielectric layer 71, an IR-reflecting layer 72 and a second dielectric layer (073). Both dielectrics layers act as transparent barrier layers to protect the TCO from the environment. Such dielectric barriers are for instance silicon oxide (SiOx), silicon nitride (SiNx), silicon oxynitride (SiOxNy) among many other possibilities. Thickness of these dielectric barrier layers are in the range of 10 to 100 nm.

In the embodiment of FIG. 9, the infrared reflecting layer 063 includes one metal layer 072 between two dielectric layers 071, 073. The layer 082 is known as a seed layer and the layer 084 as a blocking layer.

Both the seed and the blocking layer are not continuous layers with thickness below 5 nm, preferentially below 2 nm, preferentially below 1.5 nm.

The seed layer can also be replaced by a Zinc Oxide layer which has a very good affinity with silver. In that case the Zinc Oxide layer is a continuous layer and significantly thicker than a traditional seed layer.

Optionally another Zinc Oxide layer can be placed over a traditional blocking layer that covers the metal layer 072. An illustrative example of such an embodiment is shown in FIG. 23. The infrared reflecting layered structure 63 comprises a first dielectric layer 71, a first ZnO layer 91, a metal layer 072 made of an Ag-layer, a blocker layer 101, a second ZnO layer 92 and a second dielectric layer 073.

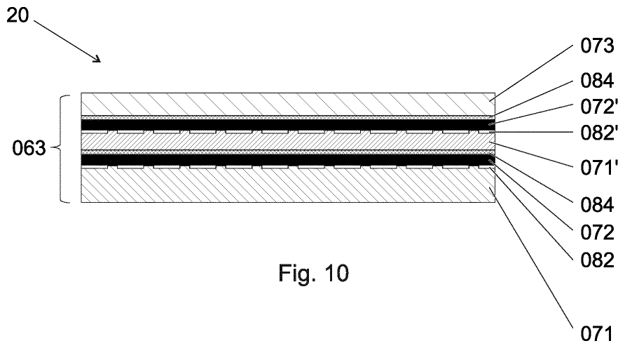

In the embodiment of FIG. 10, the infrared reflecting layer 063 includes two metal layers 072, 072′, between or separated by dielectric layers 071, 071 ‘, 073. The layer 082 is a seed layer and the layer 084 is a blocking layer.

As will be described later, the edges of these metal layers 072, 072’ can be naked with a direct air/metal interface or preferably covered by a protective layer, for example a coating or a lacquer.

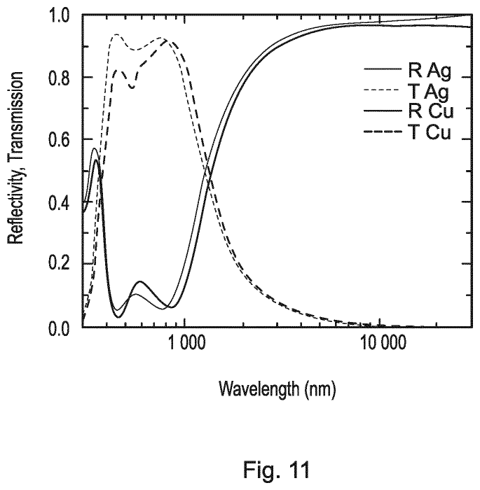

FIG. 11 illustrates a comparison of the transmission (T) and reflexion (R) properties of two infrared reflecting layered structures, one based on Silver as metal, the other based on Copper as metal, the dielectric being TiO2 in both cases.

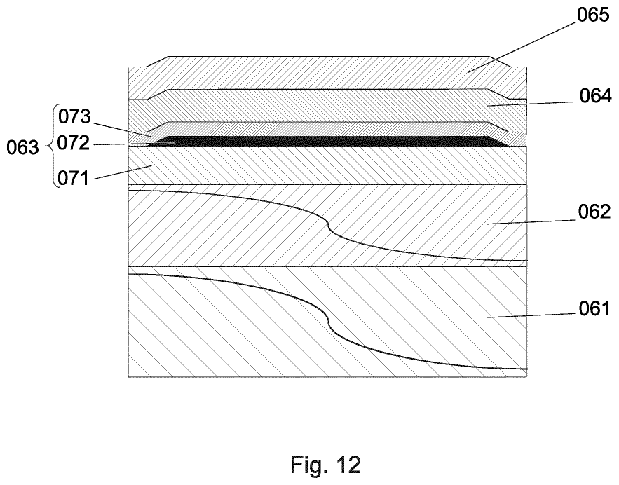

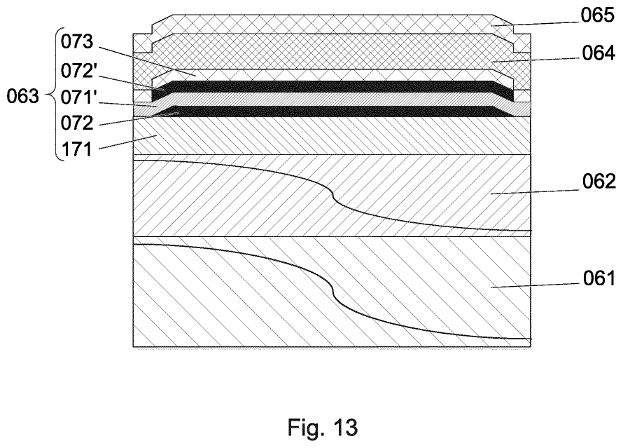

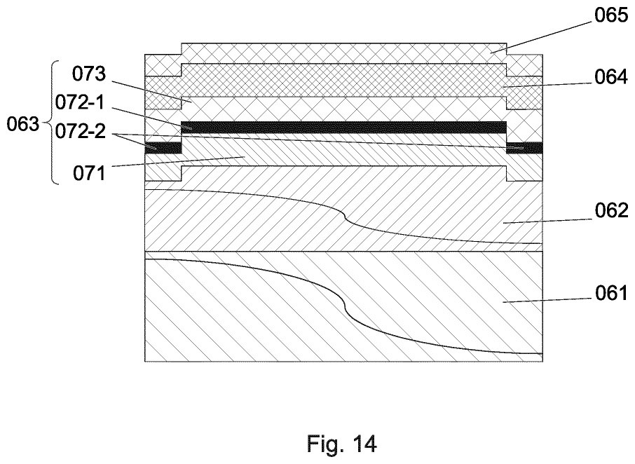

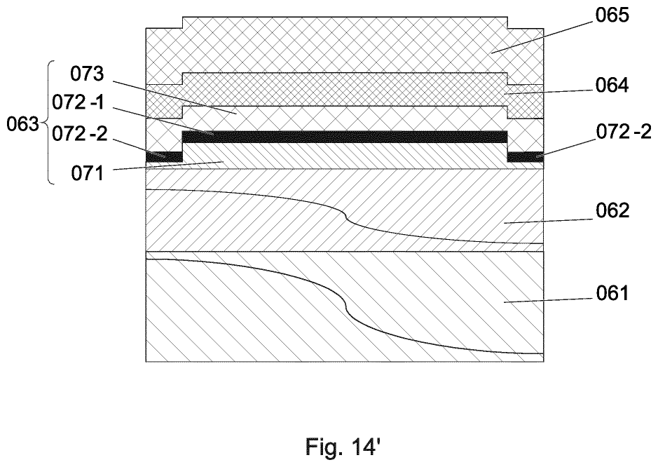

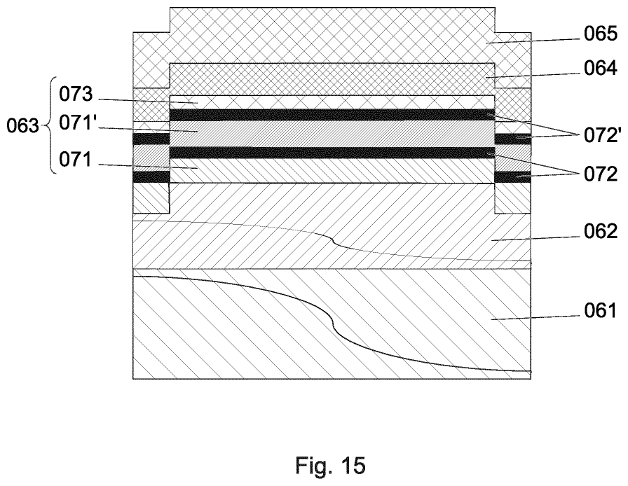

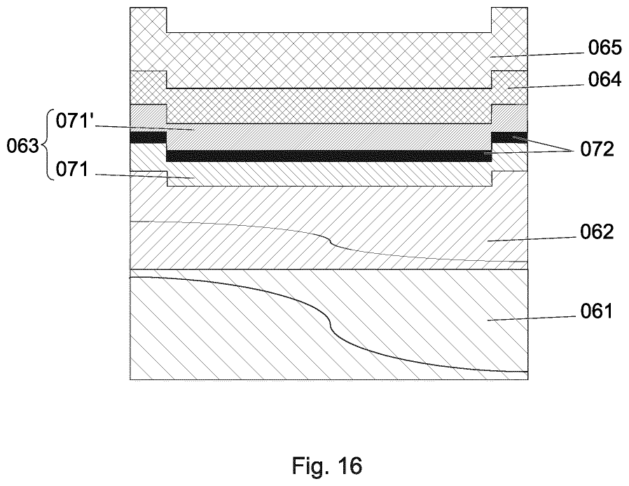

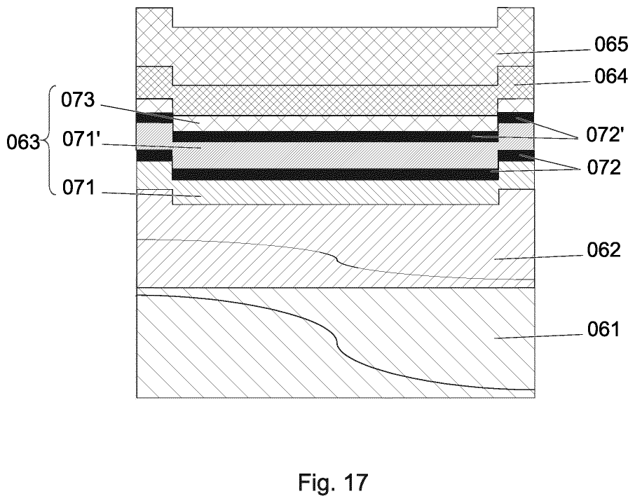

In a preferred embodiment and as shown in FIG. 12 or 13, the metal layers 072 and/or 072′ are encapsulated by the covering dielectric layer 071, 073, 071′ and have their edges protected with no direct air/metal interface.

In alternative embodiment as shown in FIGS. 14, 14′, 15, 16 and 17, the metal layer 072 can be divided in three parts: two side parts 072-2 and one inner part 072-1. The two side parts 072-2 are unprotected with a direct air/metal interface while the inner part 072-1 between those side parts has its edges protected by the covering dielectric layer or other layer.

As already disclosed, filtering strips 20 can have a length (in the x direction) corresponding to at least the width of the bay of the greenhouse in which they will be used. Once the screen has been installed in a greenhouse, an air/metal interface may exist at both longitudinal extremities of the filtering strips; those ends might be covered by a protective coating/lacquer to avoid corrosion.

In an embodiment, the deposition of the metal layer 072 is interrupted, for instance every 3.20 meters which correspond to the width of the bay of standard greenhouse in which the screen will be installed.

Therefore, the extremities of the filtering strip have no metal layer in order to suppress a possible air/metal interface. The deposition of metal can be interrupted for example at a distance between 5 and 10 centimeters from each end of the strip.

In an embodiment, the deposition of metal is interrupted at regular intervals to prevent corrosion from extending over the whole length of the metal layer. In one example, the deposition of the metal is periodically interrupted for at least 1 mm, preferably at least 5 mm. This interruption can be repeated every 10 centimetres such that if the strip 20 is cut or damaged after installation, only the portion of the metal until the next interruption (for example only 10 cm) will be subject to corrosion.

### Transparent Substrate Layer

The transparent substrate layer 061 transfers more than 80%, preferentially more than 85%, preferentially more than 90% of radiations in the photosynthetic part of the solar spectrum (ePAR range). The transparent substrate layer is preferably made of a polyester film or a fluoropolymer film (061) preferably a polyethylene terephthalate (PET). The substrate could also include polymers having terephthalate or naphthalate comonomer units, for example, polyethylene naphthalate (PEN), polyethylene terephthalate (PET), copolymers, or blends thereof.

The strips 20, and the whole screen 2, are preferably UV resistant. In one option, the substrate 061 of the strips 20 includes UV blockers.

In case the substrate layer is made of a polyester film, the film may be treated with a UV absorber so as to absorb up to 99% of UV radiations. An example of such an ultraviolet (UV) absorber film is described in U.S. Pat. No. 6,221,112. Melinex® 454 or ST505 polyester films and Tedlar® (available from DuPont Teijin Films, “DuPont′) are examples of such preferred films.

Additionally, the film may have been surface treated with chemicals or plasma to improve adhesion thereto.

In a preferred embodiment, the transparent substrate layer 061 of the filtering strips absorbs at least 30% of the radiations in the MIR range, preferentially 50% or more.

If a polyester film is used as transparent substrate film layer, the total thickness of the film is preferably 30 micrometers or less. The thickness of the single or multilayer polyester film strip is preferably higher than 10 micrometers. Preferably, the thickness of the film is at least 14 and not more than 25 micrometers; further preferred at least 14.5 micrometers and less than 21 micrometers. If the thickness of the film is below 10 micrometers, the risk of film damages with crack formation during the final application in the greenhouse increases and the mechanical strength of the film will no longer be sufficient to accommodate the pulling forces in the screens arising during use. Above 40 micrometers, the film becomes too stiff and in the opened pulled-out state the screen gives rise to “foil bales” which are too large and give excessive shading. When a fluoropolymer is used, the thickness can be reduced given the exceptional mechanical properties of such polymer.

If no underlayer is deposited under the insulator/metal/insulator stack 063, the upper side of the substrate 061 should have high adhesion with dielectric material and be very smooth in order to reduce the risk of pinholes that will reduce the life expectancy of the screen.

Smoothness of the upper side of the substrate 061 can be obtained by selecting a substrate having a low amount of anti-blocker particles, preferably a lower amount than the amount normally used at manufacturing stage, at least on one of the two faces of the substrate.

### Underlayer

An underlayer 062 between the substrate 061 and the stack 063 can be bond together with the underlying substrate 061 and the overlying infrared reflective layered structure 063, improving the robustness, hardness, and durability of these underlying and overlying optical layers. The layer 063 includes a metal layer 072 that can be prone to atmospheric corrosion; however, the underlayer 062 provides a high level of durability in terms of resistance to cracking even though the underlayer 062 does not cover the infrared reflective layer 063. As a result, the strip 22 has increased mechanical strength and greater resistance to abrasion, cracking, and scratching without negatively impacting the MIR reflectivity. Stated differently, the underlayer 062 protects the metallic infrared reflective layer 063 from abrasion and scratching.

Infrared Reflecting Layer with One Metal Layer

The infrared reflecting layered structure 063 overlays either the substrate 061 or the optional underlayer 062.

Referring to FIG. 8, the infrared reflecting layered structure 063 comprises a metal layer 072 which is highly reflective at infrared wavelengths but thin enough to be partially transparent to radiations in the photosynthetic part of the solar spectrum, disposed between two layers of transparent dielectric material 071 and 073 which reduce the reflection and increase transmission of radiations in the photosynthetic part of the solar spectrum through the structure.

The metal layer 072 is selected from the group consisting of aluminium, copper, nickel, gold, silver, platinum, palladium, tungsten, titanium, or an alloy thereof. The metal layer 072 may be comprised of any metal that is highly reflective in the infrared range, including, but not limited to, a metal selected from the group consisting of aluminum, copper, nickel, gold, silver, platinum, palladium, tungsten, titanium, or any alloy thereof.

The metal layer 072 is sufficiently thick so as to be continuous, and sufficiently thin so as to ensure that the infrared reflecting structure 063 will have the desired degree of transmission of radiations in the photosynthetic part of the solar spectrum, the desired degree of reflexion of the near infrared part of the solar spectrum, and the desired degree of reflection in the MIR range.

The metal layer 072 preferably has a physical thickness of about 5 to about 50 nm.

A “metal layer” may also be a transparent conducting oxide, preferably an Indium-Tin-Oxide (ITO) comprising 3-10% of Tin Oxide, in the context of the present invention or a fluorine tin oxide (FTO).

In the case the “metal layer” is a transparent conducting oxide, the physical thickness is higher than in the case the metal layer is a pure metal. Depending on the chosen conducting oxide, the thickness may vary between 100 nm and 1′000 nm preferentially between 150 nm and 500 nm.

Other dielectrics which are transparent to radiations in the photosynthetic part of the solar spectrum may be suitable as transparent dielectric layers 071, 073, including, but not limited to silicon dioxide, silicon nitride, silicon oxide, silicon oxynitride, silicon nitride, or mixtures thereof. However, material having a high refractive index and an almost zero extinction coefficient are preferred. One essential property of this dielectric is to offer good barrier to air atmosphere and protect the metal layer from corrosion.

Some transparent conductive oxides, selected but not limited to from the group consisting of Indium Zinc Oxide (IZO), Indium Tin Oxide (ITO), Antimony Tin Oxide (ATO), indium oxide, zinc oxide, titanium oxide, tin oxide, silicon aluminum oxide and other metal oxides, or mixtures thereof could also be used as transparent dielectric layers 071, 073 if sufficiently thin.

As shown on FIG. 8, additional layers 082, 084 can be added to promote nucleation of the metal layer 072 adhesion of the thicker dielectric layers 071, 073, and/or prevent oxidation of the metal layer 072 during the deposition of the dielectric layer 073. The thin layer 082 is referred to as the seed layer and the thin layer 084 as the blocking layer. They are sufficiently thin so that they do not substantially alter the optical properties of the stack and can be comprised of any metal selected from the group consisting of nickel, chromium, niobium, gold, platinum, cobalt, zinc, molybdenum, zirconium, vanadium, and alloys thereof, they can be in the form of oxide or nitride. Preferred material but not limited to are NiCr, NiCr(N), ZnO, Ti.

Depending on the material chosen for the seed layer, the thickness of the seed layer can range from a thickness of below one atomic layer to 20 nm.

In the case Zinc Oxide (ZnO) is chosen, the thickness will allow the layer to be continuous.

Infrared Reflecting Structure with Two Metal Layers

In a further preferred embodiment according to the current invention, a structure with two metal layers is used to significantly improve the transmission of radiations in the photosynthetic part of the solar spectrum versus the near infrared part of the solar spectrum without significant impact on the reflectivity of thermal radiations at 300K in the mid infrared spectrum.

With reference to the embodiment of FIG. 10, the stack can comprise five optically functional layers as follows: dielectric 071/seed 082 I metal 072/blocking 084/dielectric 071′/seed 082′/metal 072′/blocking 084/dielectric 073 (D/M/DD/M/D). The dielectric layer 071 ‘ sandwiched between the two metal layers 072 and 072’ can be made of two different dielectric layers, one overlaying the second.

Further refinements based on different trade-offs between reflection, transmission and cost of production are possible. These could be done by employing, for example, different metal layer, metal layers of unequal thickness, different dielectric materials, and/or different dielectric layer thicknesses.

As discussed more fully below, the types and amounts of metal and metal alloys in the infrared reflective layer can be manipulated to achieve the desired MIR reflectivity and shading.

### Protective Overcoat

Preferably, a protective overcoat 064 such as a hard ceramic silicon oxynitride (SiOxNy), Zirconium oxide (ZrC₂), Zirconium silicon oxynitride (ZrSiOxNy), aluminium oxynitride (AIOxNy), a Titanium oxide (TiOx) or mixtures of these materials could also be added over the final transparent conductive or dielectric layer of the infrared reflecting structure (063) to improve the mechanical and physical properties of the filtering strips without adverse effects on the thermal and optical performance.

The thickness of the protective overcoat layer is at least 10 nm. Preferably at least 12 nm, further preferred at least 15 nm.

In a preferred embodiment, the protective overcoat layer has a maximum thickness of 200 nm.

The overcoat should not significantly absorb the MIR radiations nor change significantly the optical property of the filtering strips.

### Top Coat

The protective top coat 065 is transparent and seals the surface of the sputtered infrared reflective layer(s) 063 and should be very thin (for example, less than 100 nm, or less than 50 nm in the case of a fluropolymer containing topcoat, such that there is no significant effect on the composite reflexion in the MIR range.

The top coat is preferentially made from a fluorocarbon-based material and is preferentially deposited by a sputtering-process, PECVD, iCVD or PVD.

In a particularly preferred embodiment according to the present invention the topcoat is hydrophobic or superhydrophobic. The condensation of moisture on the film is hence greatly reduced. This increases the lifespan of the infrared reflecting layers.

### Edge Protection/Encapsulation

In a first embodiment, there is an air/metal interface at the edges of the metal layer of the filtering strips.

With reference to FIGS. 12, 13, 14, 14′, 15, 16, 17 and 24 the edges of the metal layer 072 and/or the inner section of the metal layer are protected to avoid a direct interface between air/metal.

With reference to FIGS. 12 and 13, the metal layer 072 and 072′ are encapsulated by the dielectric layer 073, 071 ‘ and/or by the optional overcoat layer 064 which are deposited such that the edges of the metal layer are protected and not in contact with air.

With reference to the embodiments of 14, 14’, 15, 16 and 17, the metal layer 072 is divided in three parts, two side parts 072-2 and one inner part 072-1. The side parts 072-2 have a width smaller than the inner part, for example inferior to 0.5 mm, preferentially inferior to 0.25 mm compared to a width between 3.0 and 10.0 mm or more for the inner part. The inner part is isolated from the side part and from other layers of the stack in which it will be encapsulated.

In a particularly preferred embodiment according to the current invention, the encapsulation is achieved by atomic layer deposition (ALD), chemical vapour deposition (CVD) or plasma-enhanced chemical vapour deposition (PE-CVD) of a multilayer AI2O3/TiO2 stack. A substrate is coated with layer stacks according to any of FIGS. 7, 8, 9, 10 or other layer stacks presented before or hereafter. The coated substrate is then cut into stripes, with a preferred with of 2-20 mm and rolled in a mini-roll. The stripes are moved to an ALD, CVD or PE-CVD chamber, where AI2O3/TiO2 multilayer films are grown on all sides of the rolls hence of the stripes by AI2O3 and TiO2 deposition processes known from the state of the art. An illustrative example of a layer stack according to the present invention with edges protected by a multilayer Al2O3/TiO2 film is shown in FIG. 24. An infrared reflecting layered structure 63 comprises a first dielectric layer 71, a metal layer 72 and a second dielectric layer 73. The edges of the metal layer 72 and the adjoining dielectric layers 71, 73 are covered with a multilayer film 111, 111′, encapsulating the edges. The layers exposed after cutting the coated sample are hence encapsulated and protected from deterioration due to oxygen or moisture. The stripes can then be woven into a greenhouse screen according to any embodiments of the present invention.

Furthermore given that both PECVD and ALD are very conformal process, the edges are perfectly covered and sealed.

### The Infrared Reflecting Layered Structure

### One Copper Containing Layer Infrared Reflecting Structure

An example of infrared reflecting structure for filtering strips is illustrated with reference to FIG. 9. This structure is adapted for low-cost screens, such as screens comprising a majority of filtering strips whose priority is to reduce heat loss in winter rather than shading in summer. The strip comprises: a first dielectric layer 071, a seed layer 082, a copper containing layer 072, a blocking layer 084 and a second dielectric layer 073.

The first and second dielectric layer have a refractive Index of at least 1.90 at a wavelength of 550 nm which corresponds to the middle of the photosynthetic spectrum [400-700 nm].

A preferred first dielectric layer 071 comprises TiO2, and more particularly TiO2 that is mainly composed of rutile phase and that is very dense. This type of TiO2 has a refractive index of 2.41 at 510 nm. Alternatively, a SnO2 layer, a Nb2O5 layer, a SiO2 layer, a Zinc-Tin-Oxide layer or a combination of these layers could be used.

A preferred second dielectric layer 073 comprise a silicon nitride such as Si₃N₄.

The thicknesses of the first and second dielectric layers can be in the 20-50 nm range. The thicknesses of the different layers, including the substrate, are adapted to each other so that strip 20 transfers at least 70% of the radiations in the photosynthetic part of the solar spectrum at normal incidence and reflect at least 90% of the MIR at normal incidence.

A preferred metal layer comprise copper and up to 30 wt % of another element such as for example: silver, aluminium gold, palladium, indium or zinc and/or a mixture thereof. The use of copper reduces the cost of production as seed layer is not needed and increase the speed of deposition in a roll-to-roll production process by “liberating” one chamber of deposition for a low DDR layer such as TiO2 or Si3N4. Copper is also cheaper than other metal layer such as silver or gold and easier to protect from risk of corrosion, for example with special alloys or special organic coating. Copper based infrared reflecting structure have a tendency to absorb the blue and green part of the photosynthetic spectrum which on the one hand is negative as absorbed radiations are transformed in heat but in the other hand can be seen as positive as radiations in the red part of the photosynthetic spectrum are often preferred.

The thickness of the metal layer is comprised between about 5 nm and about 50 nm in thickness, depending upon the required shading property wanted of the film.

A blocking layer can comprise a Nichrome Nitride NiCrNx layer such as Hastelloy™ (available from Haynes International) or Inconel™ (available from Special Metals Co.) and as described in U.S. Pat. No. 6,859,310, deposited with a thickness between 0.5 and 10 nm, for example 1 nm.

The spectral performance of a copper based infrared reflecting structure is shown in FIG. 11. In this simulation, the dielectric layers 071 and 073 are made of titanium oxide (TiO₂) with a thickness of 37 and 34 nm, respectively. The thickness of the silver metal layer is 9 nm. It can be seen that the system fulfils the requirement for MIR reflection and high visible transmission, as well as proving some shading with absorption in the blue/green region of the spectrum and reflexion in the NIR region of the spectrum which in both cases privileged the red region of the spectrum which is the most photosynthetic. If more shading is necessary, it can be done for instance by increasing the thickness of the copper layer.

### One Silver Containing Layer Infrared Reflecting Structure

An infrared reflecting structure for filtering strips adapted for medium-cost screens comprises a majority of filtering strips offering good heat loss reduction in winter and a good shading in summer. The stack of the strips comprises: a first dielectric layer 071, a seed layer 082, a silver containing layer 072, a blocking layer 084 and a third dielectric layer 073.

In a preferred embodiment, the silver containing layer comprises a non-tarnishing silver alloy for instance an alloy of gold and silver, or of gold, palladium and silver.

In a preferred embodiment the silver containing layer is a nontarnishing silver alloy without precious metals such as gold and palladium, for instance a Cora™ alloy proposed by Materion inc.

### Two Silver Containing Layer Infrared Reflecting Structures

A reflecting structure for filtering strips adapted for premium screens is illustrated on FIG. 9. At least 80% of the strips of such a screen should have excellent heat loss reduction in winter as well as excellent shading in summer with strong selectivity between Near-Infrared/Photosynthetic radiations rejection.

The stack of this film comprises: a first dielectric 071, a seed layer 082, a first silver containing layer 072, a blocking layer 084, a second dielectric layer 071 ‘, a second seed layer 082’, a second silver containing layer 072′, a second blocking layer 084 and a third dielectric layer 073.

### Properties of the Screen

In one embodiment, the infrared reflecting layered structure 063 of the filtering strips is arranged so that the whole screen provides following behaviour in the following ranges of wavelength:

| Range | Wavelength | | Behaviour of the screen |
|---|---|---|---|
| UV | 0.3-0.3 | μm | Preferably blocks the UV. Might be |
| | | | transparent to UVs. Resist to UVs |
| ePAR | 0.4-0.75 | μm | Transparent. |
| | | | Preferably more transparent for red light |
| | | | than for green or blue light |
| | | | Might have a transparency between 40% |
| | | | and 80% for shading. |
| NIR | 0.75-2.5 | μm | Transparent, or reflected |
| MIR | 3-40 | μm | At least 40% absorbed by the side that |
| | | | faces the crop |
| | | | At least 80% reflected by the side that |
| | | | faces the sky |
| FIR | >40 | μm | Reflected or transparent |

In one embodiment, this screen reflects near infrared radiations in a wavelength range between 850 and 2500 nm, or preferably between 800 nm and 2500 nm, preferably between 750 and 2500 nm, but is transparent, or at least more transparent, to radiations in the ePAR range.

To reduce costs, this screen might have a transparency coefficient higher than 20% in the NIR range.

Therefore, a large portion of solar radiations in the ePAR range are transmitted to the plants inside the greenhouse, while a large portion of radiations in the infrared range, in particular in the middle infrared range, are absorbed or reflected, thus limiting the heat stress on the plant protected by such a filter while reducing the heat losses due to emission of MIR and FIR radiations by the plants within the greenhouse.

The stack of thin films can be more transparent for red light than for green or blue light. Green radiations are less photosynthetic than for instance red and blue and there is only a limited impact on crop productivity below the screen but a high impact on incoming energy inside the greenhouse hence on internal temperature and crop transpiration.

For example, the infrared reflecting layered structure of the stack can be more transparent to wavelengths around 660 nm+/−30 nm than to wavelength around 450 nm. This property is interesting at seedling stage when the shading capabilities of the screen is expected to be the most important. This can be done by choosing layers and layers arrangement promoting reflection or absorption of blue/green relative to red.

The filter may be arranged to reject 20% of the radiations in the 500 nm to 565 nm range (“green range”).

### Mixing Different Types of Strips

The screen 2 can comprise a mix of filtering strips 20 and non-filtering strips.

Non filtering strips, such as transparent strips, diffusive strips, fully reflective strips with or without reflectivity in the middle infrared, semitransparent strips with or without reflectivity in the middle infrared and others can be used in a screen for controlling the properties of the whole screen and for reducing its cost.

The different types of strips are combined so as to ensure for the whole screen:
i) a significant reduction of heat loss by convection, and
ii) a reduction of heat losses by radiations by more than 80% while shading of photosynthetic part of the solar spectrum is lower than 60%, or a reduction of heat loss by radiation by more than 70% while shading of the photosynthetic part of the solar spectrum is lower than 40%.

In one embodiment, the screen comprises a mix of filtering strips highly transparent in the photosynthetic part of the solar spectrum but with the upper face that faces the sky which is highly reflective for thermal radiations in the middle infrared spectrum, with strips providing no transmission in the photosynthetic part of the solar spectrum but with the face intent to face the sky highly reflective for thermal radiations in the middle infrared spectrum. The filtering strips can be based on an infrared reflecting structure made of one ultra-thin layer of silver containing layer. The second strips can be based for instance on aluminised. The mix of aluminised strip with filtering strips provides a low-cost screen with efficient shading level while providing excellent heat loss reduction.

In another embodiment, the screen has a mix of different filtering strips with different filtering structures as described above.

In yet another embodiment, the screen comprises a mix of strips transparent to the full solar spectrum with filtering strips; those filtering strips can be based on an infrared reflecting structure having two silver containing layers with high near infrared rejection toward the photosynthetic part of the solar spectrum. If the number of transparent strips is reduced compared to the amount of filtering strips, the desired filtering properties of the screen will be achieved. Moreover, such a screen will be more transparent than a screen only made of filtering strips. If the transparent strips are transparent to UVs and based for instance on a fluoropolymer, it will help insects to navigate in the greenhouse as UVs radiations is of foremost importance for them. Such a mix might also offer improved fire resistance, notably if the filtering strips are not low flammable, but transparent strips are or the reverse.

In yet another embodiment, the screen comprises a mix of three type of strips, for instance filtering strips, aluminised strips and diffusive strips.

Other mixes of strips within a screen could be considered.

### Manufacturing Methods

The filtering strips can be produced from a film, the “filtering film” which is then slit in strips at the screen fabrication stage.

The method of manufacturing a filtering film can comprise:
i) providing a transparent substrate film;
ii) depositing and structuring different layers over the transparent substrate film.

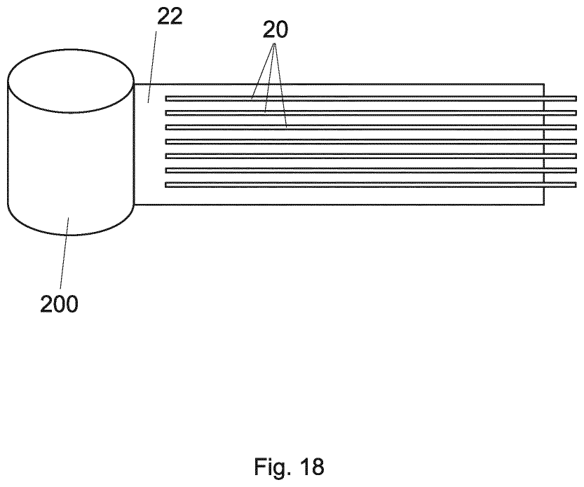

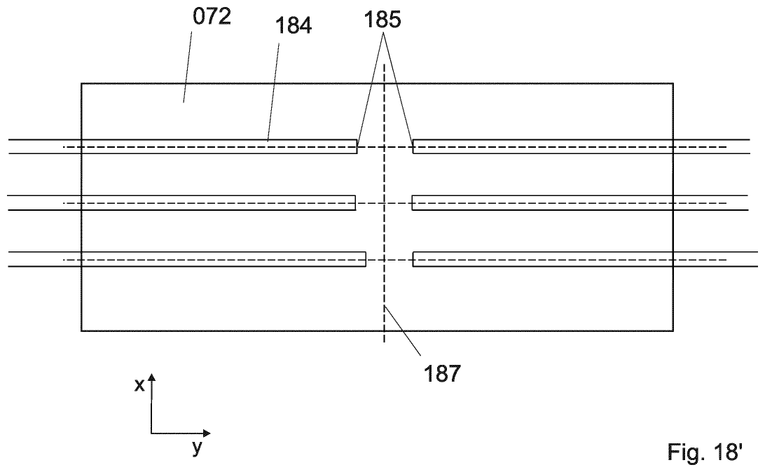

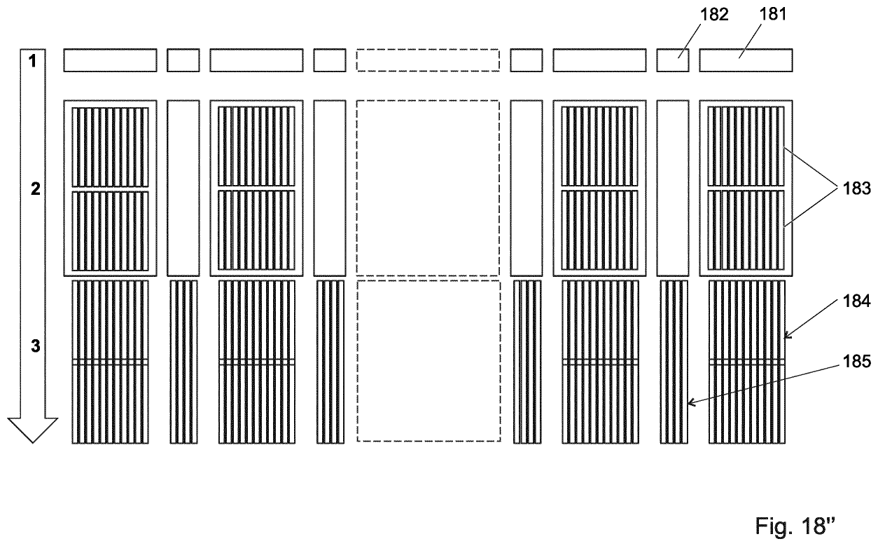

As illustrated on FIG. 18, one possible method of manufacturing the screen of the invention comprising:
i) providing rolls 200 of filtering films 22 and of other films (diffusive, transparent, . . . );
ii) depositing thin film layers over the substrate, as described previously; iii) cutting the different films in strip 20s;
iv) incorporating the different strips in a textile framework.

### Manufacturing Method of the Filtering Film

The filtering film 22 is cut from a roll of foil corresponding to the transparent substrate layer 061 of the above-described filtering strips 20. The foil 22 can have a width comprised between at least the width of one filtering strip and at most five meters, preferably at most two meters which is the maximal width of widely available roll-to-roll PVD deposition production lines.

Different treatments including plasma treatments, degassing and the different layers of the filtering strips will be carried out on the filtering film 22, using methods such as slot die, Physical Vapor Deposition or Atomic Layer Deposition.

The different layers 062-065 are then deposited over this substrate 061.

In one embodiment, the deposition of the metal layer 072s is interrupted at regular intervals 185 along the y direction, such as every 3.20m, 6.40 m, 9.60 m or 12.80 m corresponding to the span width of standard greenhouse. The length of the interruption is preferably at least 10 centimetres, preferably 20 centimetres or more. 187 is a cut line.

The reference 184 shows a portion of the metal layer 072 that is etched in the longitudinal direction x. The metal layer 072 is thus interrupted at regular intervals 184 such as every 10 centimetres corresponding over a distance of at least 1 millimetre, preferably 5 millimetres. This can be done with a shutter that is open/close over the sputtering source/metal source in the metal deposition chamber of the roll-to-roll production line.

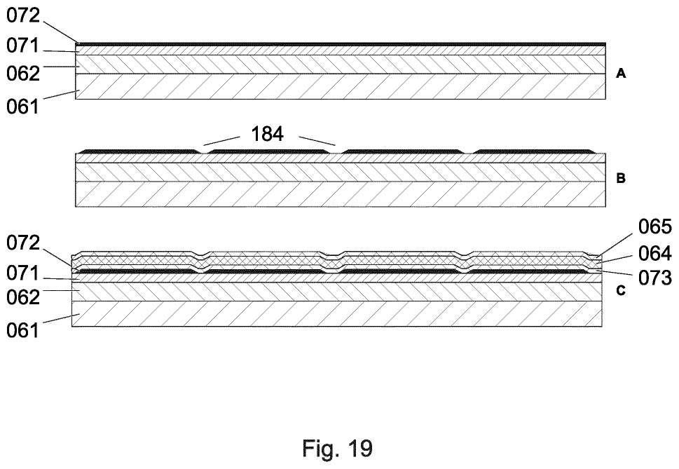

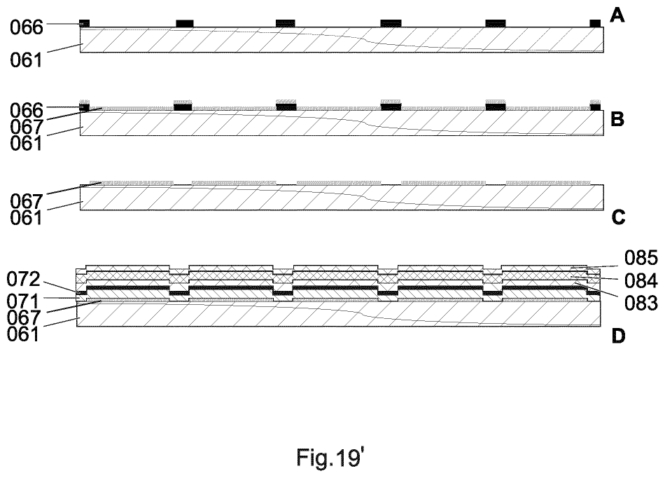

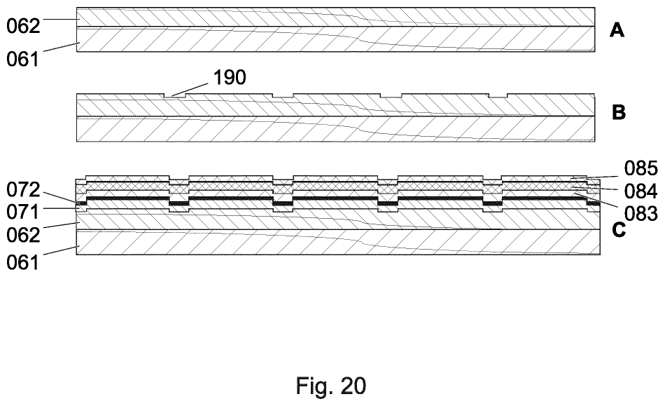

A first embodiment of the manufacturing method, as shown in FIG. 19, comprises the steps of:
A) Depositing continuously onto the foil of a transparent substrate 061 all the layers 062-065, such as an underlayer 062, a dielectric layer 071, a seed layer (not represented), the metal layer 072
B) Creating interruptions (184) into the metal layer 072 by removing strips of the metal layer area with a set periodicity, for example by plasma etching, embossing, cutting, punching, laser scribing or laser ablating. In one embodiment, thin interruptions of 0.001 mm to 0.1 mm width are created at high frequency with a periodicity in the order of 3 to 20 time the interruptions width. This approach permits a cutting at random locations in the foil. In an other embodiment, the interruptions are 0.2 to 1.0 mm wide and repeat at a period of 3 to 7 mm corresponding to the width at which the foil is cut to strips (20)
C) Depositing the remaining layers of the filtering strips onto said interrupted metal layer of step (B) such as a blocking layer, a second dielectric layer 073, an overcoat layer 196 and a top-coat layer 197.

An optional second metal layer 072′ can also be interrupted periodically.

In another embodiment, the manufacturing method comprises a step of printing oil in fine strips of 0.1 to 1.0 mm before the deposition of the metal layer 072, everywhere where the metal should be removed. The oil will prevent adhesion of the metal on the dielectric 071 and will be evaporated by the different plasma, high temperature environment. This is a special case of lift process that can be done inline and is state of the art.

In a second embodiment of the manufacturing method of the filtering film, illustrated with FIG. 20 comprises the steps of:
A) Providing a foil of a transparent substrate 061 optionally covered with an underlayer 062 as previously described;
B) Creating periodical grooves 190 onto the surface obtained at step A, e.g. by hot- or UV-embossing. The depth of the interruptions 190 can be typically in a range from 5 to 100 nm, for example 8 to 30 nm less than the thickness of the second dielectric layer 073, and/or less than the added thickness of the second dielectric layer 073 and the overcoat layer. The hot-embossing may be carried out using a thermoplastic polymer foil such as a polyester (e.g. polyethyleneter-ephthalate (PET), polycarbonate (PC), polyacrylmethacrylate (PMMA), or polyvinylbutyral film), or using a hot-embossible coating on the substrate; In one embodiment, grooves (190) with a width of 0.001 mm to 0.1 mm are created at high frequency with a periodicity in the order of 3 to 20 times the groove width. This approach permits a cutting at random locations in the foil. In an other embodiment, the grooves are 0.2 to 1.0 mm wide and repeat at a period of 3 to 7 mm corresponding to the width at which the foil is cut to strips (20);
C) Deposing the remaining layers of the filtering strips onto said interrupted structured substrate such as a dielectric layer 071, a seed layer (not represented), the metal layer 072, a blocker layer (not represented), a second dielectric layer 073, an overlayer 084, and a top-coat 085.

In a variation of this embodiment illustrated in FIG. 19′, the so called lift-off manufacturing method comprises the steps of:
A) printing with sacrificial ink periodically separated parallel strips (066). The printing of the sacrificial ink can be done by slot die coating, and microgravure deposition or preferably flexography printing.
B) the substrate is coated with a transparent coating 067 of a controlled thickness. The thickness of the coating 067 can be typically in a range from 5 to 100 nm, for example 8 to 30 nm less than the thickness of the second dielectric layer 073, and/or less than the added thickness of the second dielectric layer 073 and the overcoat layer. It is important to have a difference in thickness in the same order of magnitude of the thickness of the second dielectric layer, so that the second dielectric layer covers the edges of the inner part of the metal layer.
C) the printed pattern of step A is removed, for instance by placing the film in an ultrasonic bath with acetone and ethyl acetate, hence removing in periodic stripes the sacrificial ink and the coating 067 of step B covering the sacrificial ink.
D) of this variant comprises a deposition of the remaining layers of the filtering strips onto said interrupted structured substrate such as a dielectric layer 071, a seed layer (not represented), the metal layer 072, a blocker layer (not represented), a second dielectric layer 073, a second metal layer (not represented), a third dielectric (not represented), an overlayer 084 and a top-coat 085. In one embodiment, strips (066) are printed with a width of 0.01 mm to 0.1 mm at high frequency with a periodicity in the order of 3 to 20 times the strip width. This approach permits cutting at random locations in the foil. In another embodiment, the printed strips 067 are 0.2 to 1.0 mm wide and repeat at a period of 3 to 7 mm corresponding to the width at which the foil is cut to strips (20).

In a third embodiment of the manufacturing method of the filtering film, shown on FIG. 21, comprises the steps of:
A) Depositing continuously onto a foil of a transparent substrate 061 an optional underlayer 062 and a dielectric layer 071, as previously described.
B) Creating interruptions 190 into the dielectric layer 071 by removing strips of the dielectric layer area for example by plasma etching, embossing, cutting, punching, laser scribing or laser ablating; This process can be done online or in a separate process. In one embodiment, interruptions (190) with a width of 0.001 mm to 0.1 mm are created at high frequency with a periodicity in the order of 3 to 20 times the interruptions width. This approach permits cutting at random locations in the foil. In another embodiment, the interruptions are 0.2 to 1.0 mm wide and repeat at a period of 3 to 7 mm corresponding to the width at which the foil is cut to strips (20);
C) Depositing the optional seed layer and the metal layer 072. In a preferred embodiment, the metal layer is deposited obliquely under an angle from the range 10°-70° relative to the normal surface of the layer 071. This provides a void in the metal layer 072 that will be later covered with the second dielectric layer 073 and thus provides encapsulation. This is preferred as at the ablation stage (B), the ablation of the dielectric layer being often not sharp while the aim is to create a clear rupture of the metal layer.

In a preferred embodiment, all the deposition, structuring, patterning, printing steps are done in a roll-to-roll process and preferably in a continuous process.

A fourth embodiment of the of the manufacturing method of the filtering film comprises the steps of:
A) Depositing continuously roll-to-roll onto the foil of a transparent substrate 061 all the layers 062-065, such as an underlayer 062, a first dielectric layer 071, a seed layer (not represented), the metal layer 072, a second dielectric layer 073, an overcoat layer 064, a top coat layer 065. At the end of this step, a coated roll is produced.
B) Slitting the coated roll in many “mini-rolls” which have a width equal to the final strip. A typical width of the strips is between 2 mm and 10 mm but they can also be wider hence the width of the mini-rolls.
C) Placing all the mini-rolls in an ALD batch coated or PECVD batch coated and depositing a barrier layer such as a repetition of Al₂O₃/TiO2 layers or a SiO₂ layer on the sides of the batches. Given both PECVD and preferably ALD are conformal processes the barrier layer will cover exactly the edges of the minirolls hence protecting the edges of the strips. The typical size of the barrier layer is 10 nm, preferably 20 nm, preferably 100 nm. When the mini-roll is unrolled a section of the strip is represented in FIG. 24 (where only a first dielectric layer 071, a metal layer 072 and a second dielectric layer 073 is represented as well as the barrier layer (111, 111′) such as a repetition of Al₂O₃/TiO2 structure on the sides of the pancake/strips.

### Manufacturing Method of the Screen

In one manufacturing method of the filtering film, as shown on FIG. 18″, in step 1, different rolls of filtering film 181 and non-filtering film 182 are placed on a same axis to be unrolled in parallel. The addition of the lengths of the different rolls corresponds to the width of the screen to be produced.

During step 2, the different rolls are unrolled in parallel and input to a cutting station. During step 3, the films are advantageously cut into narrow strips, for example with a width of 3-10 mm. Those strips are combined with polyester yarn (preferably also UV stabilized) to produce a fabric for the screen. The strips of filtering film can be combined with strips of other films unrolled in parallel. For the filtering film, the cutting tool of the cutting station should cut precisely between two metal layer strips, such that the cutting tool does not damage the protection of the metal layer.

Each strip 20 is then cut and separated from the other strips. To cut the strips, a blade based system, an ultrasonic device or alternatively a laser can be used. The laser could cauterize the lateral edges of the strips by melting the substrate.

The separated strips 20 are then knit or weaved into a fabric with threads 12.

A gliding band can be mounted to the screen after its production, to facilitate its installation.

The embodiments presented here are only a selection of representative examples according to the invention. It is obvious to the person skilled in the art that further embodiments according to the current invention can be realized by combining individual technical features of the examples and embodiments. Such embodiments are equally part of the current invention.

When the chosen manufacturing method of the filtering film involves the production of side protected mini-rolls of which the edges of the stripes are already protected, different mini-rolls of filtering film 181 and mini-rolls of non-filtering film 182 that don't need edge protection are placed on the same axis to be unrolled in parallel. The addition of the lengths of the different rolls corresponds to the width of the screen to be produced.

During step 2, the different mini-rolls are unrolled in parallel.

Those strips are combined with polyester yarn (preferably also UV stabilized) to produce a fabric for the screen. The strips of filtering film can be combined with strips of other films unrolled in parallel.

The separated strips are then knit or weaved into a fabric with threads 12.

In a third manufacturing method of the filtering film, the stack is deposited as a repetition of a periodic structure. When the period is minimal and each repetition gives a structure thin enough to be not significant and characterised by a width inferior to 200 nm preferentially inferior to 50 nm, preferentially inferior to 10 nm, cutting anywhere the filtering film will sacrifice only one structure hence a small percentage of the stripe as the next structure will be protected. Hence a second manufacturing process of the screen is to start from such a roll, cut it in line with a cutting station that is not very precise as it is no longer needed to cut precisely on a slitting track. Then the resulting strips are knit or wave the screen as it is currently done in the state of the art.

1. A foldable greenhouse screen comprising strips of film material that are interconnected by a yarn system of threads by means of knitting, warp-knitting or weaving process to form a continuous product, at least some of said strips being filtering strips and comprising a transparent substrate in a form of a single or multilayer polymeric film covered on a first side with an infrared reflecting layered structure, characterized in that:
said infrared reflecting layered structure (063) comprising at least one stack with a first dielectric, layer one metal layer or IR-reflecting layer and a second dielectric layer, so that said foldable greenhouse screen has: a transparency coefficient of at least 40% but no more than 80% in a range of solar radiations, and a reflection coefficient higher than 70% in a middle infrared, and that:
the at least one stack comprises corrosion protection means which protect edges of the one metal layer or IR-reflecting layer against corrosion or oxidation.

2. The foldable greenhouse screen of claim 1, wherein said foldable greenhouse screen has a transparency of at least 80% in a ePAR range or wherein said foldable greenhouse screen has a transparency coefficient of at least 60% in the range of solar radiations or wherein said foldable greenhouse screen has a reflection coefficient higher than 80% in the middle infrared.

3. The foldable greenhouse screen of any one of claim 1 or 2, wherein one side of the foldable greenhouse screen which is intended to face the sky reflects the thermal infrared radiations in the middle infrared spectrum while an other face absorbs at least 50% of thermal infrared radiations in the middle infrared spectrum, and/or wherein said infrared reflecting layered structure is arranged to reflect at least 50% of radiations within the near infrared-range.

4. (canceled)

5. The foldable greenhouse screen of claim 1, wherein said strips have a total thickness of at least 10 micrometers and at most 40 micrometers, preferably at least 11 and at most 30 micrometers, more preferred as least 14 micrometers and at most 23 micrometers, most preferred at least 14.5 micrometers and at most 20 micrometers.

6. (canceled)

7. The foldable greenhouse screen of claim 1, wherein;
the infrared reflecting layered structure comprises an organic underlayer deposited directly on the transparent substrate for providing a smooth substrate for later deposition of another layer thin film, a thickness of the organic underlayer being lower than 5 pm, preferably lower than 2 pm, and/or
said one metal layer comprises copper or silver, said one metal layer having a thickness lower than 30 nm, preferentially lower than 20 nm.

8. (canceled)

9. The foldable greenhouse screen of claim 1, wherein:
said infrared reflecting layered structure comprises a topcoat to protect the infrared reflecting layered structure from mechanical damage and corrosion, and/or the foldable greenhouse screen further comprises a seed layer between the first dielectric layer and the one metal layer, and/or
the foldable greenhouse screen further comprises a blocking layer between the one metal layer and the second dielectric layer, and/or
the foldable greenhouse screen further comprises a non-permeable protective layer for protecting edges of said at least one stack.

10. The foldable greenhouse screen of claim 9, wherein the topcoat is hydrophobic or superhydrophobic.

11. (canceled)

12. (canceled)

13. (canceled)

14. The foldable greenhouse screen of claim 1, wherein said foldable greenhouse screen has a haze of less than 18%, preferably less than 8%, most preferred less than 3%.

15. The foldable greenhouse screen of claim 1, wherein:
said one metal layer is periodically interrupted, and/or
said one metal layer does not extend to each border of the transparent substrate.

16. (canceled)

17. The foldable greenhouse screen of claim 1, wherein:
strips of different types are mixed, and/or
strips having different transparencies or reflection properties are mixed.

18. The foldable greenhouse screen of claim 1, wherein the infrared reflecting layered structure is a low-e film with an emissivity of less than 0.35, preferably less than 0.25, more preferred less than 0.15.

19. (canceled)

20. (canceled)

21. (canceled)

22. A filtering strip of a foldable greenhouse screen comprising a transparent substrate in a form of a single or multilayer polymeric film covered on a first side with an infrared reflecting layered structure, said infrared reflecting layered structure comprising at least one stack with:
a first dielectric layer,
a metal layer or IR-reflecting layer, and
a second dielectric layer,
having corrosion protection means for protecting the metal layer or IR-reflecting layer against corrosion.

23. The filtering strip of claim 22, wherein:
the corrosion protection means comprise encapsulating means for encapsulating the metal layer or IR-reflecting layer by avoiding a direct air/metal interface, and/or
edges to sides of the IR-reflecting layer are encapsulated by corrosion protection means.

24. (canceled)

25. (canceled)

26. A foldable greenhouse screen comprising strips of film material that are interconnected by a yarn system of threads by means of knitting, warp-knitting or weaving process to form a continuous product,
at least some of said strips being filtering strips, comprising a transparent substrate in a form of a single or multilayer polymeric film covered on a first side with an infrared reflecting layered structure, said infrared reflecting layered structure comprising at least one stack with:
a first dielectric layer,
a metal layer or IR-reflecting layer, and
a second dielectric layer,
having corrosion protection means for protecting the metal layer or IR-reflecting layer against corrosion.

27. The foldable greenhouse screen of claim 26, wherein:
the corrosion protection means include encapsulating means for encapsulating the metal layer or IR-reflecting layer with no direct air/metal interface, or
edges to sides of the metal layer or the IR-Reflecting layer are encapsulated by corrosion protection means.

28. (canceled)
